(19) United States
(12) Patent Application Publication
(10) Pub. No.: US 2016/0338084 A1
(43) Pub. Date: Nov. 17, 2016

(54) Device and Method of Handling PUCCH Resource for Scheduling Request

(71) Applicant: HTC Corporation, Taoyuan City (TW)

(72) Inventor: Shiang-Rung Ye, Taoyuan City (TW)

(21) Appl. No.: 15/151,484

(22) Filed: May 10, 2016

Related U.S. Application Data
(60) Provisional application No. 62/159,977, filed on May 12, 2015.

(51) Int. Cl. H04W 72/12

(52) U.S. Cl. CPC H04W 72/1231; H04W 72/1284; H04W 84/042

(57) ABSTRACT

A communication device for handling a physical uplink control channel (PUCCH) resource comprises a storage unit for storing instructions and a processing means coupled to the storage unit. The processing means is configured to execute the instructions stored in the storage unit. The instructions comprise being configured with a PUCCH resource for transmitting a scheduling request (SR) on a PUCCH secondary cell (SCell) by a network; releasing the PUCCH resource for transmitting the SR, when the PUCCH SCell is deactivated; and not transmitting the SR via the PUCCH resource on the PUCCH SCell to the network.

### CROSS REFERENCE TO RELATED APPLICATIONS

This application claims the benefit of U.S. Provisional Application No. 62/159,977, filed on May 12, 2015, which is incorporated herein by reference.

### BACKGROUND OF THE INVENTION

1. Field of the Invention

The present invention relates to a device and a method used in a wireless communication system, and more particularly, to a device and a method of handling a physical uplink control channel (PUCCH) resource for a scheduling request in a wireless communication system.

2. Description of the Prior Art

A long-term evolution (LTE) system provides high data rate, low latency, packet optimization, and improved system capacity and coverage. In the LTE system, a radio access network known as an evolved universal terrestrial radio access network (E-UTRAN) includes at least one evolved Node-B (eNB) for communicating with at least one user equipment (UE), and for communicating with a core network including a mobility management entity (MME), a serving gateway, etc., for Non-Access Stratum (NAS) control.

A LTE-advanced (LTE-A) system is an evolution of the LTE system. The LTE-A system extends cell coverage of an eNB, increases peak data rate and throughput, and includes advanced techniques, such as carrier aggregation (CA), licensed-assisted access (LAA) using LTE, etc.

According to the 3rd Generation Partnership Project (3GPP) standard, a UE may be configured with a physical uplink control channel (PUCCH) resource on a PUCCH secondary cell (SCell). However, the PUCCH SCell may be deactivated, and the PUCCH resource may be released. It is not known how the UE can perform communication operations (e.g., transmission of a scheduling request (SR)) via the PUCCH resource. In addition, the UE may also be configured with the PUCCH resource on a primary cell (PCell). According to the 3GPP standard, the UE does not know how perform the communication operations if the PUCCH resource on both the PCell and the PSCell is available.

### SUMMARY OF THE INVENTION

The present invention therefore provides a communication device and method for handling a physical uplink control channel (PUCCH) resource for a scheduling request to solve the abovementioned problem.

A communication device for handling a physical uplink control channel (PUCCH) resource comprises a storage unit for storing instructions and a processing means coupled to the storage unit. The processing means is configured to execute the instructions stored in the storage unit. The instructions comprise being configured with a PUCCH resource for transmitting a scheduling request (SR) on a PUCCH secondary cell (SCell) by a network; releasing the PUCCH resource for transmitting the SR, when the PUCCH SCell is deactivated; and not transmitting the SR via the PUCCH resource on the PUCCH SCell to the network.

A communication device for handling a physical uplink control channel (PUCCH) resource comprises a storage unit for storing instructions and a processing means coupled to the storage unit. The processing means is configured to execute the instructions stored in the storage unit. The instructions comprise being configured with a PUCCH resource for transmitting a scheduling request (SR) on a PUCCH secondary cell (SCell) by a network; keeping the PUCCH resource for transmitting the SR, when the PUCCH SCell is deactivated; and not transmitting the SR via the PUCCH resource on the PUCCH SCell to the network.

A communication device for handling a physical uplink control channel (PUCCH) resource comprises a storage unit for storing instructions and a processing means coupled to the storage unit. The processing means is configured to execute the instructions stored in the storage unit. The instructions comprise being configured with a PUCCH resource for transmitting a scheduling request (SR) on a primary cell (PCell) and a PUCCH secondary cell (SCell) by a network; and transmitting the SR via the PUCCH resource on at least one of the PCell and the PUCCH SCell to the network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

### DETAILED DESCRIPTION

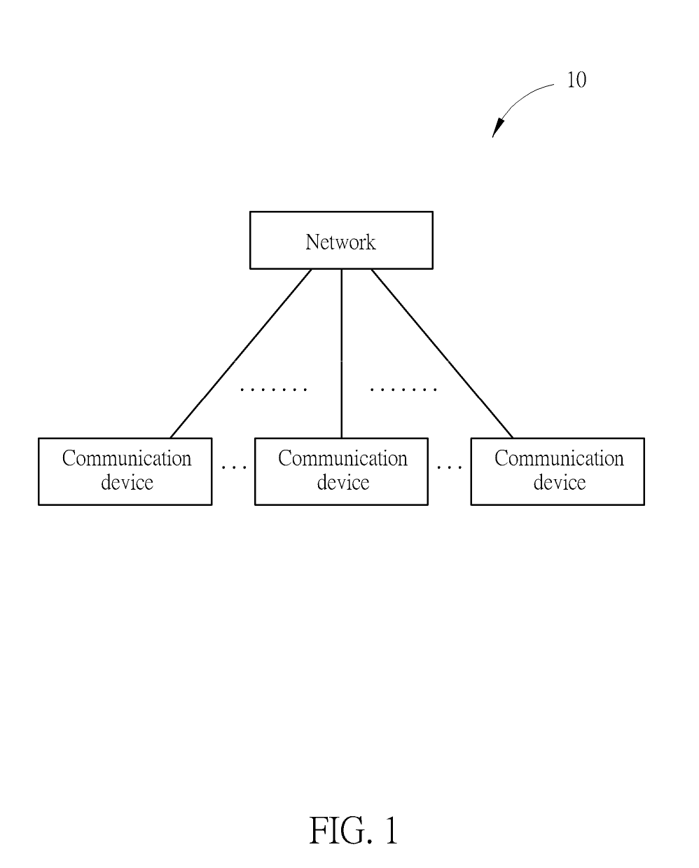

Please refer to FIG. 1, which is a schematic diagram of a wireless communication system 10 according to an example of the present invention. The wireless communication system 10 is briefly composed of a network and a plurality of communication devices. The network and a communication device may communicate with each other via one or more carriers of licensed band (s) and/or unlicensed band (s). The network and the communication device may simultaneously communicate with each other via multiple cells (e.g., multiple carriers) including a primary cell (PCell) and one or more secondary cells (SCells). The abovementioned cells may be operated in the same or different duplexing modes, i.e. frequency-division duplexing (FDD) and time-division duplexing (TDD). For example, the PCell may be operated on a licensed carrier, while the SCell may be operated on an unlicensed carrier.

In FIG. 1, the network and the communication devices are simply utilized for illustrating the structure of the wireless communication system 10. Practically, the network may be an evolved universal terrestrial radio access network (E-UTRAN) including at least one evolved Node-B (eNB) and/or at least one relay in a long term evolution (LTE) system, a LTE-Advanced (LTE-A) system or an evolution of the LTE-A system. The network may be a fifth generation (5G) network including at least one 5G base station (BS) which employs orthogonal frequency-division multiplexing (OFDM) and/or non-OFDM for communication with the communication devices. In general, a base station (BS) may also be used to refer any of the NB, the RNC, the eNB and the 5G BS.

A communication device may be a user equipment (UE), a machine type communication (MTC) device, a mobile phone, a laptop, a tablet computer, an electronic book, a portable computer system, a vehicle, an aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

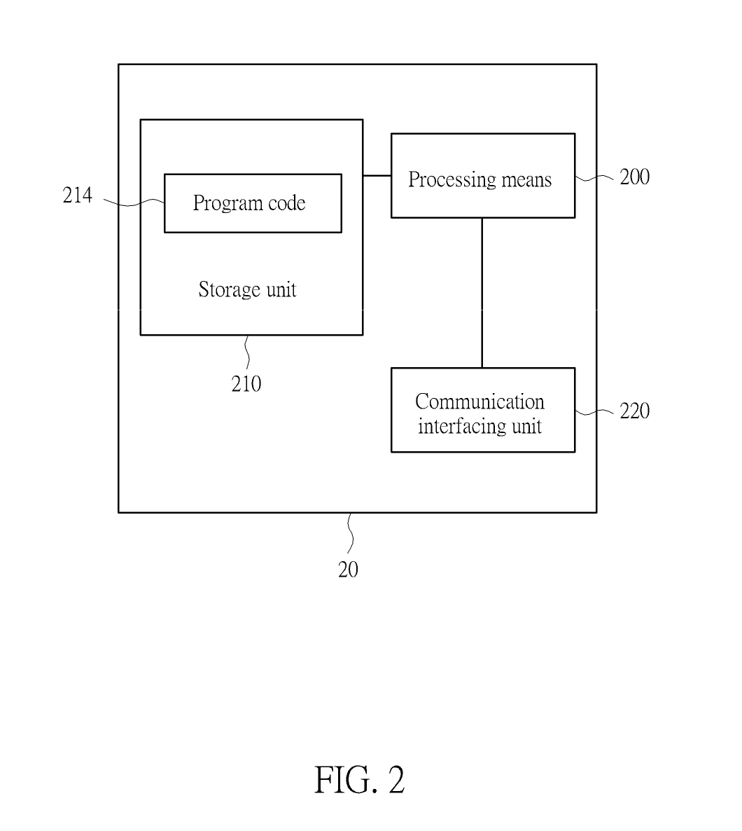

FIG. 2 is a schematic diagram of a communication device 20 according to an example of the present invention. The communication device 20 may be a communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), hard disk, optical data storage device, non-volatile storage unit, non-transitory computer-readable medium (e.g., tangible media), etc. The communication interfacing unit 220 is preferably a transceiver and is used to transmit and receive signals (e.g., data, messages and/or packets) according to processing results of the processing means 200.

In the following embodiments, a UE is used to represent a communication device in FIG. 1 to simplify the illustration of the embodiments.

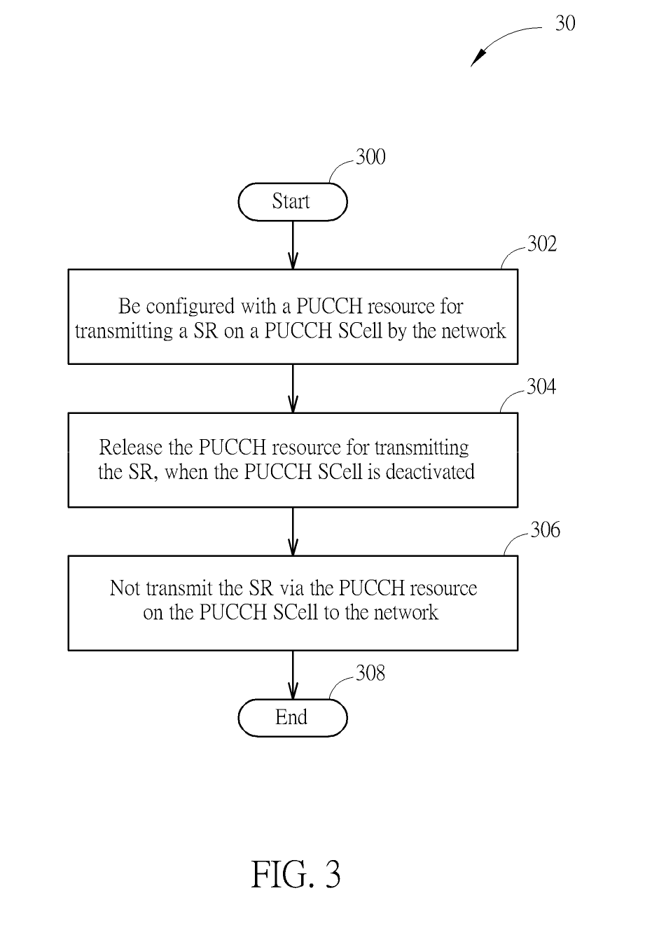

FIG. 3 is a flowchart of a process 30 according to an example of the present invention. The process 30 may be utilized in a UE, for handling a physical UL control channel (PUCCH) resource. The process 30 may be compiled into the program code 214 and includes the following steps:

Step 300: Start.

Step 302: Be configured with a PUCCH resource for transmitting a scheduling request (SR) on a PUCCH SCell by the network.

Step 304: Release the PUCCH resource for transmitting the SR, when the PUCCH SCell is deactivated.

Step 306: Not transmit the SR via the PUCCH resource on the PUCCH SCell to the network.

Step 308: End.

According to the process 30, the UE may be configured with a PUCCH resource for transmitting a SR on a PUCCH SCell by the network. After a while, the PUCCH SCell may be deactivated. Accordingly, the UE may release the PUCCH resource for transmitting the SR. In addition, the UE may not transmit the SR via the PUCCH resource on the PUCCH SCell to the network. That is, the SR is not transmitted, if the PUCCH resource of the PUCCH SCell is released. Thus, how the UE operates when the PUCCH SCell is deactivated is solved according to the process 30.

Realization of the process 30 is not limited to the above description.

In one example, the PUCCH resource may be used for transmitting channel state information (CSI) and/or a channel quality indicator (CQI). In one example, the PUCCH SCell may be deactivated by the UE, or may be deactivated by the network. In one example, the UE may deactivate the PUCCH SCell, after receiving an activation/deactivation medium access control (MAC) control element deactivating the PUCCH SCell from the network. In one example, the UE may deactivate the PUCCH SCell, after sCellDeactivationTimer associated with the PUCCH SCell expires.

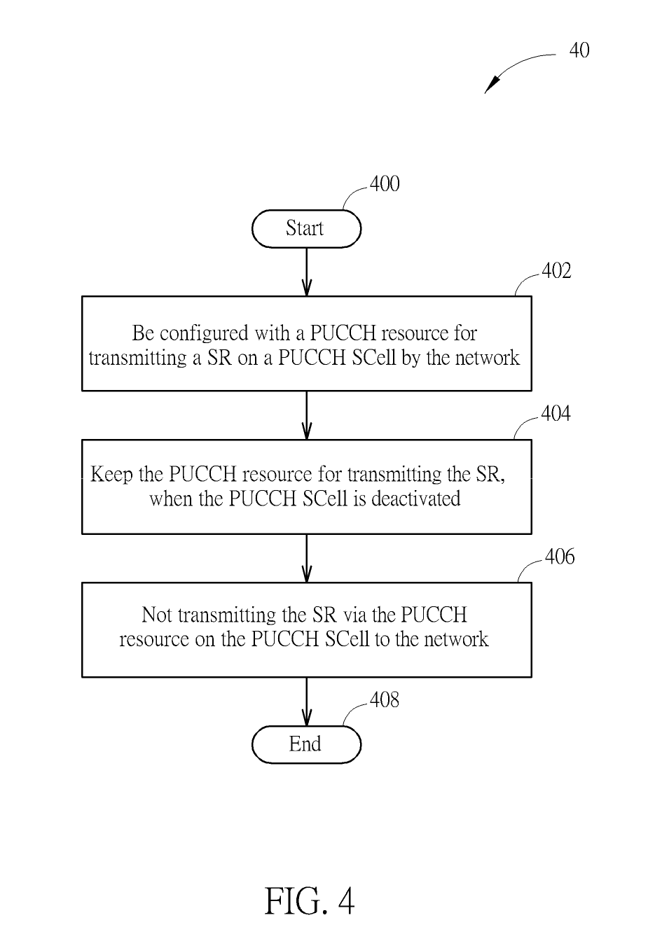

FIG. 4 is a flowchart of a process 40 according to an example of the present invention. The process 40 may be utilized in a UE, for handling a PUCCH resource. The process 40 may be compiled into the program code 214 and includes the following steps:

Step 400: Start.

Step 402: Be configured with a PUCCH resource for transmitting a SR on a PUCCH SCell by the network.

Step 404: Keep the PUCCH resource for transmitting the SR, when the PUCCH SCell is deactivated.

Step 406: Not transmitting the SR via the PUCCH resource on the PUCCH SCell to the network.

Step 408: End.

According to the process 40, the UE may be configured with a PUCCH resource for transmitting a SR on a PUCCH SCell by the network. After a while, the PUCCH SCell may be deactivated. Accordingly, the UE may keep the PUCCH resource for transmitting the SR, when the PUCCH SCell is deactivated. In addition, the UE may not transmit the SR via the PUCCH resource on the PUCCH SCell to the network. That is, the SR is not transmitted, even if the PUCCH resource of the PUCCH SCell is kept. Thus, how the UE should operate when the PUCCH SCell is deactivated is solved according to the process 40.

Realization of the process 40 is not limited to the above description.

In one example, the PUCCH resource may be used for transmitting CSI and/or a CQI. In addition, according to which the PUCCH SCell is deactivated is not limited. In one example, the PUCCH SCell may be deactivated by the UE, or may be deactivated by the network. In one example, the UE may deactivate the PUCCH SCell, after receiving an activation/deactivation medium access control (MAC) control element deactivating the PUCCH SCell from the network. In one example, the UE may deactivate the PUCCH SCell, after sCellDeactivationTimer associated with the PUCCH SCell expires.

In one example, the UE may determine that the PUCCH resource for transmitting the SR is invalid, when the PUCCH SCell is deactivated. Then, the UE may initiate a random access procedure on a PCell, if the SR is triggered. That is, the PUCCH resource becomes invalid in this example. In one example, the UE may determine that the PUCCH resource for transmitting the SR is valid, when the PUCCH SCell is deactivated. Then, the UE may initiate a random access procedure on a PCell, if the SR is triggered. Different from the previous example, the PUCCH resource is valid in this case. In one example, the UE may initiate a SR transmission procedure on the PUCCH SCell, if the SR is triggered and the PUCCH SCell is activated. Then, the UE may stop all ongoing random access procedure. The random access procedure mentioned above may be performed according to 3rd Generation Partnership Project (3GPP) standard, e.g., TS 36.321, but is not limited herein.

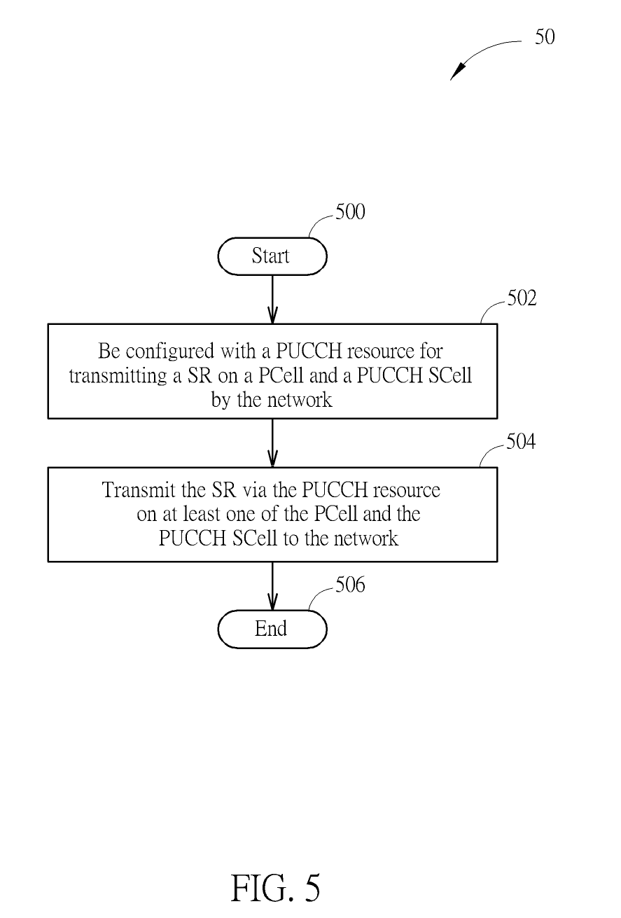

FIG. 5 is a flowchart of a process 50 according to an example of the present invention. The process 50 may be utilized in a UE, for handling a PUCCH resource. The process 50 may be compiled into the program code 214 and includes the following steps:

Step 500: Start.

Step 502: Be configured with a PUCCH resource for transmitting a SR on a PCell and a PUCCH SCell by the network.

Step 504: Transmit the SR via the PUCCH resource on at least one of the PCell and the PUCCH SCell to the network.

Step 506: End.

According to the process 50, the UE may be configured with a PUCCH resource for transmitting a SR on a PCell and a PUCCH SCell by the network. Then, the UE may transmit the SR via the PUCCH resource on at least one of the PCell and the PUCCH SCell to the network. That is, the UE may transmit the SR via the PUCCH resource on the PCell, the PUCCH resource on the PUCCH SCell, or the PUCCH resource on both the PCell and the PUCCH SCell. Thus, how the UE operates when the PUCCH resource on both the PCell and the PUCCH SCell is configured to the UE is solved according to the process 50.

Realization of the process 50 is not limited to the above description.

In one example, the SR may be transmitted via the PUCCH resource on one of the PCell and the PUCCH SCell. That is, the SR is transmitted via only one of the cells, e.g., according to a choice of the UE. Further, the one of the PCell and the PUCCH SCell may be selected according to an indication transmitted by the network. In another example, the one of the PCell and the PUCCH SCell may be selected according to that a previous SR is transmitted via the one of the PCell and the PUCCH SCell. For example, the SR is transmitted via the PUCCH resource on the PCell, if the previous SR is transmitted via the PUCCH resource on the PCell. In another example, the one of the PCell and the PUCCH SCell may be selected according to a predetermined rule, e.g., which is stored in the UE.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20.

To sum up, the present invention provides a communication device and method of handling a PUCCH resource for a SR. The communication device can handle the PUCCH properly, when a PUCCH SCell configured to the communication device is deactivated. In addition, the communication device can handle the PUCCH resource properly, when the PUCCH resource on multiple cells is configured to the communication device. Thus, the operations related to the PUCCH resources are specified for the communication device in the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a physical uplink control channel (PUCCH) resource, comprising:
a storage unit, for storing instructions of:
being configured with a PUCCH resource for transmitting a scheduling request (SR) on a PUCCH secondary cell (SCell) by a network;
releasing the PUCCH resource for transmitting the SR, when the PUCCH SCell is deactivated; and
not transmitting the SR via the PUCCH resource on the PUCCH SCell to the network; and
a processing means, coupled to the storage unit, configured to execute the instructions stored in the storage unit.

2. The communication device of claim 1, wherein the PUCCH resource is for transmitting channel state information (CSI) and/or a channel quality indicator (CQI).

3. The communication device of claim 1, wherein the PUCCH SCell is deactivated by the communication device, or is deactivated by the network.

4. The communication device of claim 1, wherein the communication device deactivates the PUCCH SCell, after receiving an activation/deactivation medium access control (MAC) control element deactivating the PUCCH SCell from the network.

5. The communication device of claim 1, wherein the communication device deactivates the PUCCH SCell, after sCellDeactivationTimer associated with the PUCCH SCell expires.

6. A communication device for handling a physical uplink control channel (PUCCH) resource, comprising:
a storage unit, for storing instructions of:
being configured with a PUCCH resource for transmitting a scheduling request (SR) on a PUCCH secondary cell (SCell) by a network;
keeping the PUCCH resource for transmitting the SR, when the PUCCH SCell is deactivated; and
not transmitting the SR via the PUCCH resource on the PUCCH SCell to the network; and
a processing means, coupled to the storage unit, configured to execute the instructions stored in the storage unit.

7. The communication device of claim 6, wherein the PUCCH resource is for transmitting channel state information (CSI) and/or a channel quality indicator (CQI).

8. The communication device of claim 6, wherein the storage unit further stores an instruction of:
determining that the PUCCH resource for transmitting the SR is valid, when the PUCCH SCell is deactivated; and
initiating a random access procedure on a primary cell (PCell), if the SR is triggered.

9. The communication device of claim 6, wherein the PUCCH SCell is deactivated by the communication device, or is deactivated by the network.

10. The communication device of claim 6, wherein the communication device deactivates the PUCCH SCell, after receiving an activation/deactivation medium access control (MAC) control element deactivating the PUCCH SCell from the network.

11. The communication device of claim 6, wherein the communication device deactivates the PUCCH SCell, after sCellDeactivationTimer associated with the PUCCH SCell expires.

12. The communication device of claim 6, wherein the storage unit further stores an instruction of:
determining that the PUCCH resource for transmitting the SR is invalid, when the PUCCH SCell is deactivated; and
initiating a random access procedure on a PCell, if the SR is triggered.

13. The communication device of claim 6, wherein the storage unit further stores an instruction of:
initiating a SR transmission procedure, if the SR is triggered and the PUCCH SCell is activated; and
stopping all ongoing random access procedure.

14. The communication device of claim 6, wherein the storage unit further stores an instruction of:
determining that the PUCCH resource for transmitting the SR is valid, when the PUCCH SCell is activated.

15. A communication device for handling a physical uplink control channel (PUCCH) resource, comprising:
a storage unit, for storing instructions of:
being configured with a PUCCH resource for transmitting a scheduling request (SR) on a primary cell (PCell) and a PUCCH secondary cell (SCell) by a network; and
transmitting the SR via the PUCCH resource on at least one of the PCell and the PUCCH SCell to the network; and
a processing means, coupled to the storage unit, configured to execute the instructions stored in the storage unit.

16. The communication device of claim 15, wherein the SR is transmitted via the PUCCH resource on one of the PCell and the PUCCH SCell.

17. The communication device of claim 16, wherein the one of the PCell and the PUCCH SCell is selected according to an indication transmitted by the network.

18. The communication device of claim 16, wherein the one of the PCell and the PUCCH SCell is selected according to that a previous SR is transmitted via the one of the PCell and the PUCCH SCell.

19. The communication device of claim 16, wherein the one of the PCell and the PUCCH SCell is selected according to a predetermined rule.
